(19) United States
(12) Patent Application Publication
(10) Pub. No.: US 2024/0396386 A1
(43) Pub. Date: Nov. 28, 2024

(54) STATOR ASSEMBLY OF WATER PUMP

(71) Applicant: DELTA ELECTRONICS, INC., Taoyuan City (TW)

(72) Inventors: Yong-Cheng WANG, Taoyuan City (TW); Meng-Yu CHEN, Taoyuan City (TW); Shih-Han HUANG, Taoyuan City (TW)

(21) Appl. No.: 18/530,047

(22) Filed: Dec. 5, 2023

(30) Foreign Application Priority Data
May 26, 2023 (CN) 202321303936.2

(51) Int. Cl. H02K 1/18; H02K 1/16

(52) U.S. Cl. CPC H02K 1/18; H02K 1/16

(57) ABSTRACT

This disclosure is a stator assembly of a water pump. The stator assembly includes a shell seat and a stator component. The shell seat includes an inner side wall and hooks. The stator component includes a bobbin, a silicon lamination set and a wiring set. The bobbin covers the silicon lamination set and exposes an outer peripheral surface of the silicon lamination set. The wiring set is arranged on the bobbin, and snapping holes are disposed on a bottom side of the bobbin. The inner side wall is attached to the outer peripheral surface, and the snapping holes are engaged with the hooks. Therefore, the stator component may be firmly integrated into the shell seat through simple positioning structures.

### BACKGROUND OF THE DISCLOSURE

### Technical Field

The technical field relates to a motor, and more particularly relates to a stator assembly of a water pump.

### Description of Related Art

A stator of the water pump motor is an important component. In the related art, the installation of the stator assembly is to place the stator component in the shell seat, and then the stator assembly is fixed by epoxy resin or shrapnel to ensure the stator component may not move.

Specifically, the stator component of the related art is fixed in the shell seat by epoxy resin. However, it not only increases the production cost, but also requires using additional tools for disassembly or repair, and that results in inconvenience and increases the disassembly time. Moreover, when the stator is positioned above the shell seat by the cover, the clamping force and clamping position the cover may cause instability, and that may cause the stator to move or vibrate on the shell seat. Thus, the operation efficiency and service life of the water pump are greatly reduced.

In view of the above drawbacks, the inventor proposes this disclosure based on his expert knowledge and elaborate researches in order to solve the problems of related art.

### SUMMARY OF THE DISCLOSURE

One object of this disclosure is to provide a stator assembly of a water pump, which the stator component is firmly integrated into the shell seat through simple positioning structures to improve the service life of the water pump and the manufacturing yield of the water pump, and further simplify the assembly process of the stator assembly of the water pump.

This disclosure is a stator assembly of a water pump. The stator assembly includes a shell seat and a stator component. The shell seat includes an inner side wall and a plurality of hooks disposed on the inner side wall. The stator component includes a bobbin, a silicon lamination set and a wiring set. The bobbin covers the silicon lamination set and exposes an outer peripheral surface of the silicon lamination set. The wiring set is arranged on the bobbin, and a plurality of snapping holes are disposed on a bottom side of the bobbin. The inner side wall is attached to the outer peripheral surface, and the snapping holes are engaged with the hooks respectively.

In one embodiment of this disclosure, the shell seat includes a receiving space surrounded by the inner side wall, and the hooks are arranged oppositely on a bottom side of the receiving space.

In one embodiment of this disclosure, each of the hooks includes a bottom plate and a pair of stopping plates. The bottom plate is buckled in each of the snapping holes, and the pair of stopping plates are connected to the bottom plate and includes a first guiding slope respectively.

In one embodiment of this disclosure, the shell seat includes a shut-off disposed on one side of each hook.

In one embodiment of this disclosure, the bobbin includes a retaining wall protruding from the silicon lamination set. The snapping holes are arranged spacedly on the retaining wall, and two cutouts are disposed on two sides of each snapping hole respectively.

In one embodiment of this disclosure, the retaining wall includes a second guiding slope disposed on one side of each snapping hole.

In one embodiment of this disclosure, a guiding rib is disposed on one of the inner side wall and the outer peripheral surface, and a guiding groove is disposed on the other one of the outer peripheral surface and the inner side wall corresponding to the guiding rib.

This disclosure is a stator assembly of a water pump. The stator assembly includes a shell seat and a stator component. The shell seat includes an inner side wall and a plurality of pillars disposed on the inner side wall. The stator component includes an outer peripheral surface and a plurality of elastic arms, and each elastic arm includes a perforation. The inner side wall is attached to the outer peripheral surface, and each of the pillars is extended into the perforation correspondingly.

In one embodiment of this disclosure, each of the pillars includes a first guiding slope.

In one embodiment of this disclosure, the shell seat includes a shut-off disposed on one side of each pillar.

In one embodiment of this disclosure, the stator component includes a bobbin, a silicon lamination set and a wiring set. The bobbin covers the silicon lamination set and exposes an outer peripheral surface of the silicon lamination set. The silicon lamination set includes the outer peripheral surface. The wiring set is disposed on the bobbin, and the elastic arms are disposed on a bottom side of the bobbin.

In one embodiment of this disclosure, the bobbin includes a retaining wall protruding from the silicon lamination set. The elastic arms are arranged spacedly on the retaining wall, and two cutouts are disposed on two sides of each elastic arm respectively.

In one embodiment of this disclosure, each of the elastic arms includes a second guiding slope disposed on one side of the perforation.

In one embodiment of this disclosure, a guiding rib is disposed on one of the inner side wall and the outer peripheral surface, and a guiding groove is disposed on the other one of the outer peripheral surface and the inner side wall corresponding to the guiding rib.

This disclosure is a stator assembly of a water pump. The stator assembly includes a shell seat and a stator component. The shell seat includes a plurality of tenons. The stator component includes a plurality of elastic arms, and each elastic arm includes a slot. The stator component is attached to the shell seat, and the tenon are engaged with the slots respectively and correspondingly.

In one embodiment of this disclosure, the shell seat includes an inner side wall to form a receiving space, and the tenons are disposed spacedly on a bottom side of the receiving space.

In one embodiment of this disclosure, each tenon includes a first guiding slope, and each of the elastic arms includes a second guiding slope disposed on one side of the slot.

In one embodiment of this disclosure, the shell seat includes a shut-off disposed on one side of each tenon.

In one embodiment of this disclosure, the stator component includes a bobbin, a silicon lamination set and a wiring set. The bobbin covers the silicon lamination set and exposes an outer peripheral surface of the silicon lamination set. The wiring set is disposed on the bobbin, and the elastic arms are disposed on a bottom side of the bobbin.

In one embodiment of this disclosure, the bobbin includes a retaining wall protruding from the silicon lamination set. The elastic arms are arranged spacedly on the retaining wall, and two cutouts are disposed on two sides of each elastic arm respectively.

In comparison with the related art, the stator assembly of a water pump of this disclosure includes a plurality of hooks (pillars or tenon) disposed on the inner side wall of the shell seat, and a plurality of snapping holes (perforations or slots) are disposed on the bottom side of the bobbin of the stator component. Moreover, the inner side wall of the shell seat is forced fit to the outer peripheral surface of the stator component, and the snapping holes are engaged with the hooks respectively. Accordingly, the stator component is firmly integrated into the shell seat through simple positioning structures to improve the service life of the water pump, the manufacturing yield of the water pump, and further simplify the assembly process of the stator assembly of the water pump.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective schematic view of the stator assembly of a water pump in this disclosure.

FIG. 2 is a perspective exploded schematic view of the stator assembly of a water pump in this disclosure.

FIG. 3 is a cross sectional view of the stator assembly of a water pump in this disclosure.

FIG. 4 is a partially enlarged view of FIG. 3.

FIG. 5 is a cross sectional view of another side of the stator assembly of a water pump in this disclosure.

FIG. 6 and FIG. 7 are partially enlarged views of FIG. 5.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

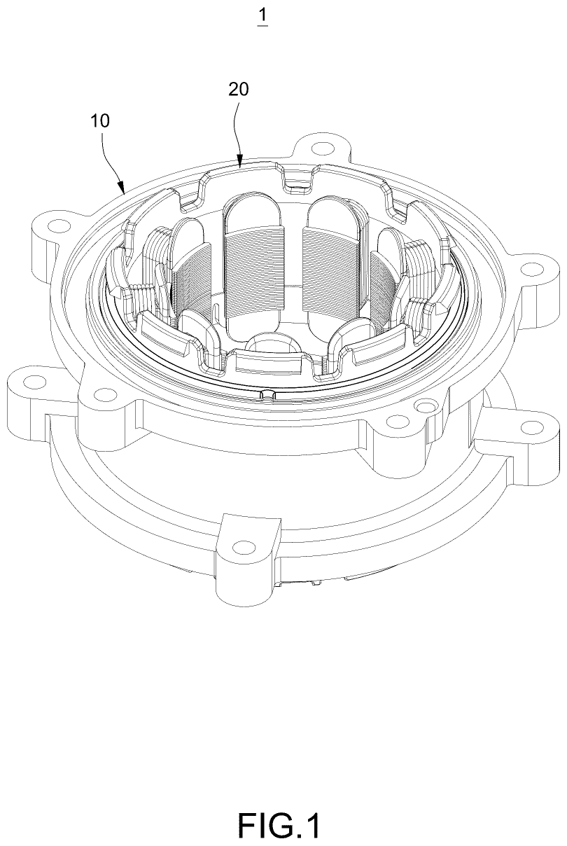

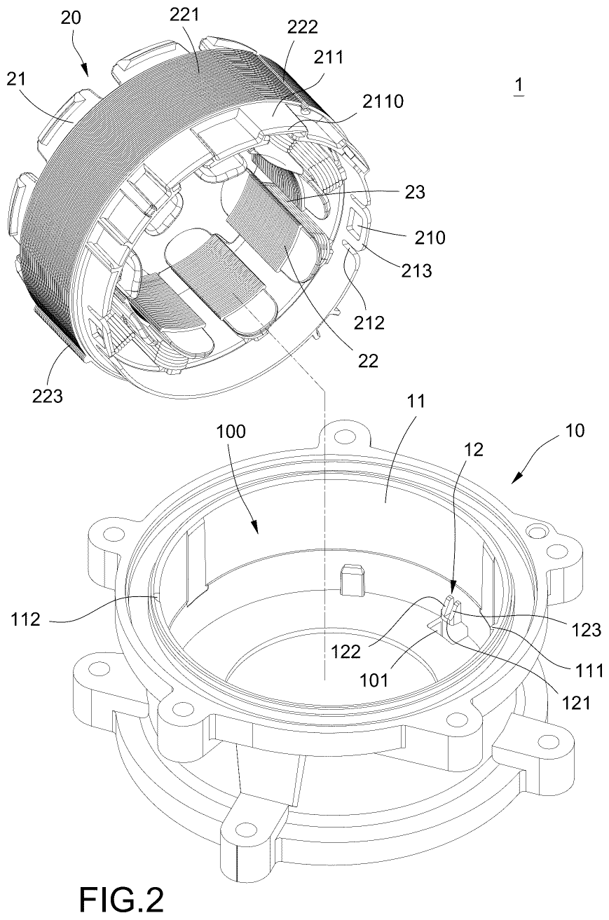

Please refer to FIG. 1 and FIG. 2, which are a perspective schematic view and a perspective exploded schematic view of the stator assembly of a water pump in this disclosure. This disclosure is a stator assembly 1 of a water pump, the stator assembly 1 includes a shell seat 10 and a stator component 20. The stator component 20 is fixed in the shell seat 10 through a positioning structure. More detail of the positioning structure of the shell seat 10 and the stator component 20 is described as follows.

The shell seat 10 includes an inner side wall 11, and a plurality of first positioning structures 12 such as hooks, tenons or pillars, etc., are disposed on the inner side wall 11.

Specifically, the shell seat 10 includes a receiving space 100 surrounded by the inner side wall 11. The first positioning structures 12 (such as, hooks, tenons or pillars, etc.) are disposed oppositely and spacedly and on the bottom side of the receiving space 100.

It is worth noticing that the shell seat 10 of this disclosure includes a shut-off 101 disposed on one side of each first positioning structure 12 (such as, hooks, tenons or pillars, etc.) to make the first positioning structures 12 (such as, hooks, tenons or pillars, etc.) be integrally formed with the shell seat 10 through mold design. Thus, the effects of improving the service life of the water pump and the manufacturing yield of the water pump, and simplifying the assembly process of the stator assembly of the water pump are achieved through the technology of this disclosure.

The stator component 20 includes a bobbin 21, a silicon lamination set 22 and a wiring set 23. The bobbin 21 covers the silicon lamination set 22 and exposes an outer peripheral surface of the silicon lamination set 22. Additionally, the wiring set 23 is arranged on the bobbin 21, and a plurality of snapping holes 210 are disposed on a bottom side of the bobbin 21.

In more detail, the bobbin 21 includes a retaining wall 211 protruding from the silicon lamination set 22. Additionally, the snapping holes 210 are arranged spacedly on the retaining wall 211, and two cutouts 212 are disposed on two sides of each snapping hole 210 respectively. Thus, the effects of improving the service life of the water pump and the manufacturing yield of the water pump, and simplifying the assembly process of the stator assembly of the water pump are achieved through the technology of this disclosure.

In other words, the bobbin 21 includes a plurality of elastic arms 213 disposed on a bottom side thereof, and the snapping hole 210 (perforation or slot) is disposed on each elastic arm 213. The elastic arms 213 are arranged spacedly on the retaining wall 211, and two cutouts 212 are disposed on two sides of each elastic arm 213 respectively. Thus, the effects of improving the service life of the water pump and the manufacturing yield of the water pump, and simplifying the assembly process of the stator assembly of the water pump are achieved through the technology of this disclosure.

Furthermore, each first positioning structure 12 (such as, hooks, pillars or tenons, etc.) includes a first guiding slope 123. The arrangement of the first guiding slope 123 facilitates the engaging of the first positioning structure 12 with the snapping holes 210 (or the slot corresponding to the tenon) to achieve the fastening therebetween.

In this embodiment, each first positioning structure 12 includes a hook. Each hook includes a bottom plate 121 and a pair of stopping plates 122. The pair of stopping plates 122 are connected to the bottom plate 121 and include a first guiding slope 121 respectively.

In one embodiment of this disclosure, the elastic arm 213 of the retaining wall 211 includes a second guiding slope 2110 disposed on one side of each snapping hole 210 (perforation or slot). The arrangement of the second guiding slope 2110 facilitates the placing of the stator element 20 into the shell seat 10 to improve the service life of the water pump and the manufacturing yield of the water pump, and simplify the assembly process of the stator assembly 1 of a water pump.

It is worth noticing that the inner side wall 11 of the shell seat 10 includes a guiding rib 111. On the other hand, the outer peripheral surface 221 of the silicon lamination set 22 includes a trench 222, and the trench 222 is disposed corresponding to the guiding rib 111. Thus, the effects of improving the service life of the water pump and the manufacturing yield of the water pump, and simplifying the assembly process of the stator assembly of the water pump are achieved through the technology of this disclosure. When the stator component 20 of this disclosure is assembled into the shell seat 10, the shell seat 10 and the stator component 20 may be positioned with each other through the guiding rib 111 and the trench 222.

In other words, the inner side wall 11 of the shell seat 10 may also include a guiding groove (trench) 112. Moreover, the outer peripheral surface 221 of the stator component 20 may include a protrusion rib (or guiding rib) 223. The guiding groove 112 is disposed corresponding to the protrusion rib 223. When the stator component 20 of this disclosure is assembled into the shell seat 10, the shell seat 10 and the stator component 20 may be positioned with each other through the guiding groove 112 and the protrusion rib 223. Accordingly, the shell seat 10 and the stator component 20 are fixed through the first positioning structures 12 engaging with the snapping holes 210. Thus, the effects of improving the service life of the water pump and the manufacturing yield of the water pump, and simplifying the assembly process of the stator assembly of the water pump are achieved through the technology of this disclosure.

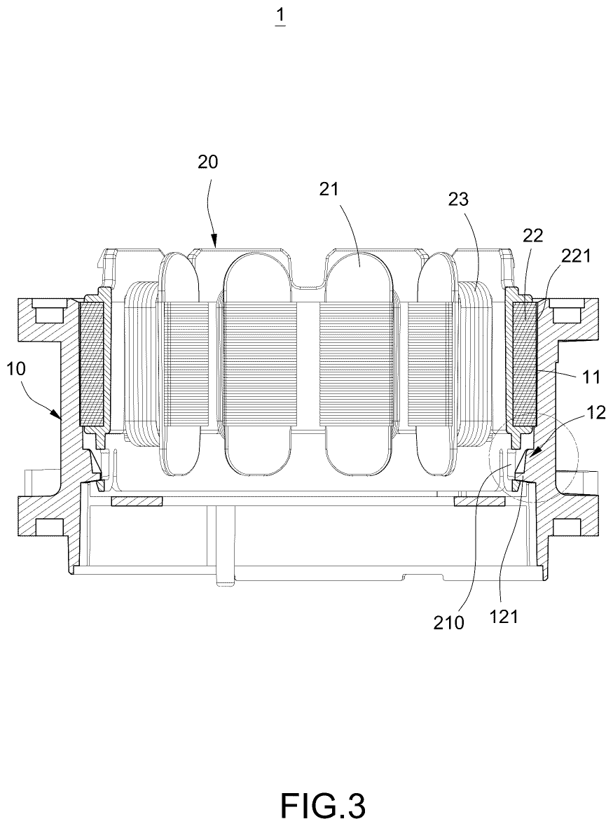

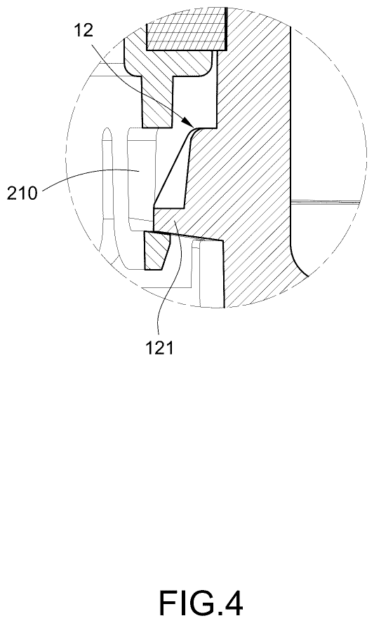

Please refer to FIG. 3 and FIG. 4, which are a cross sectional view of the stator assembly of a water pump in this disclosure and a partially enlarged view of FIG. 3. The inner side wall 11 of the shell seat 10 of this disclosure is forced fit to the outer peripheral surface of the stator component 20, and the snapping holes 210 are engaged with the first positioning structures 12 (such as, hooks, pillars or tenons, etc.) respectively. In other words, the first positioning structures 12 (such as, hooks, pillars, or tenons, etc.) are extended into the snapping holes 210 (perforations or slot) correspondingly and respectively, so that the stator component 20 is combined with the shell seat 10. In this embodiment, the bottom plate 121 of the first positioning structures 12 is buckled in each snapping hole 210. Thus, the effects of improving the service life of the water pump and the manufacturing yield of the water pump, and simplifying the assembly process of the stator assembly of the water pump are achieved through the technology of this disclosure.

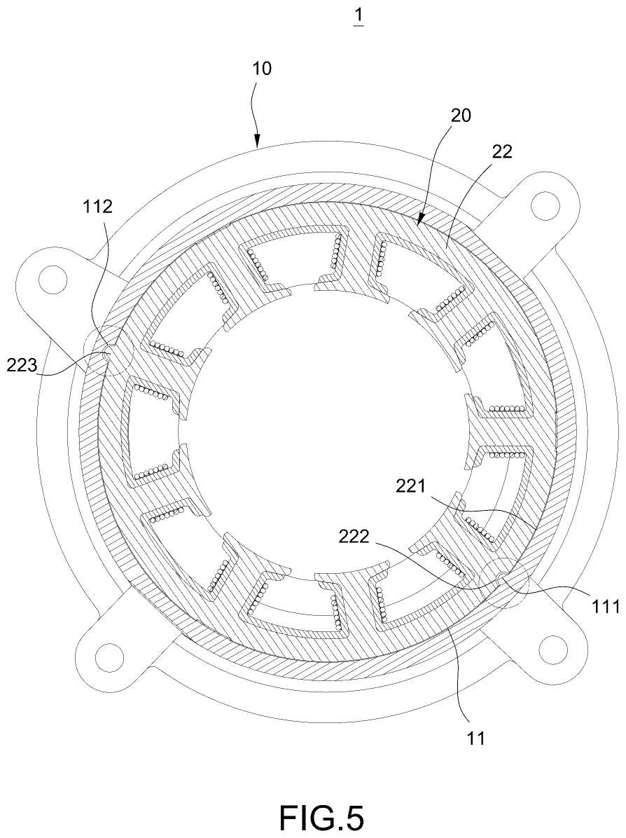

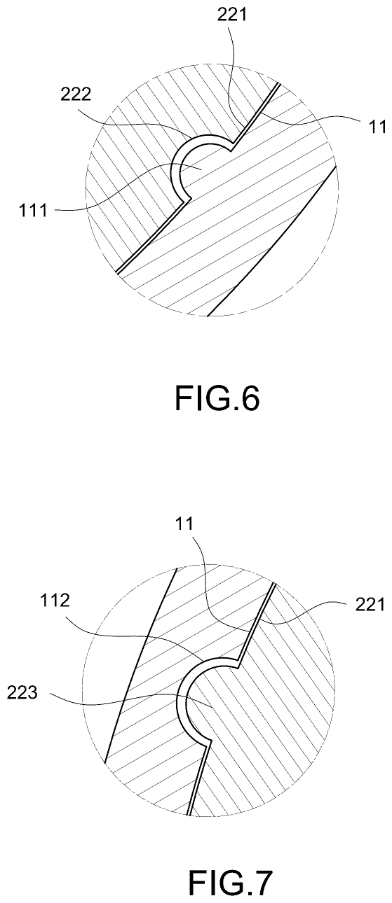

Please further refer to FIG. 5 to FIG. 7, which are a cross sectional view of another side of the stator assembly of a water pump in this disclosure and two partially enlarged views of FIG. 5. The stator component 20 of this disclosure is fastened not only through the first positioning structures 12 of the shell seat 10 engaging with the snapping holes 210, but also the trench 222 located on one side of the stator component 20 and the guiding rib 111 of the shell seat 10, and the protrusion rib 223 on another side of the stator component 20 and the guiding groove 112 of the shell seat 10 are positioned with each other. Accordingly, the stator component 20 may be firmly integrated into the shell seat 10 through simple positioning structures. Thus, the effects of improving the service life of the water pump and the manufacturing yield of the water pump, and simplifying the assembly process of the stator assembly of the water pump are achieved through the technology of this disclosure.

While this disclosure has been described by means of specific embodiments, numerous modifications and variations could be made thereto by those skilled in the art without departing from the scope and spirit of this disclosure set forth in the claims.

What is claimed is:

1. A stator assembly of a water pump, the stator assembly comprising:
a shell seat, comprising an inner side wall and a plurality of hooks disposed on the inner side wall; and
a stator component, comprising a bobbin, a silicon lamination set and a wiring set, the bobbin covering the silicon lamination set and exposing an outer peripheral surface of the silicon lamination set, the wiring set arranged on the bobbin, and the bobbin comprising a plurality of snapping holes defined on a bottom side thereof;
wherein, the inner side wall is attached to the outer peripheral surface, and the plurality of hooks are engaged to the plurality of snapping holes respectively.

2. The stator assembly according to claim 1, wherein the shell seat comprises a receiving space surrounded by the inner side wall, and the hooks are arranged oppositely on a bottom side of the receiving space.

3. The stator assembly according to claim 2, wherein each of the hooks comprises a bottom plate and a pair of stopping plates, the bottom plate is buckled to each of the snapping holes, and the pair of stopping plates are connected to the bottom plate and respectively comprise a first guiding slope.

4. The stator assembly according to claim 1, wherein the shell seat comprises a shut-off defined on one side of each of the hooks.

5. The stator assembly according to claim 2, wherein the bobbin comprises a retaining wall protruding from the silicon lamination set, the snapping holes are arranged spacedly on the retaining wall, and two cutouts are defined on two sides of each of the snapping holes respectively.

6. The stator assembly according to claim 5, wherein the retaining wall comprises a second guiding slope disposed on one side of each of the snapping holes.

7. The stator assembly according to claim 1, further comprising a guiding rib disposed on one of the inner side wall and the outer peripheral surface, and a guiding groove disposed on another one of the outer peripheral surface and the inner side wall corresponding to the guiding rib.

8. A stator assembly of a water pump, the stator assembly comprising:
a shell seat, comprising an inner side wall and a plurality of pillars disposed on the inner side wall; and
a stator component, comprising an outer peripheral surface and a plurality of elastic arms, and each of the elastic arms comprising a perforation;
wherein, the inner side wall is attached to the outer peripheral surface, and the pillars are extended to a plurality of perforations correspondingly.

9. The stator assembly according to claim 8, wherein each of the pillars comprises a first guiding slope.

10. The stator assembly according to claim 8, wherein the shell seat comprises a shut-off defined on one side of each of the pillars.

11. The stator assembly according to claim 8, wherein the stator component comprises a bobbin, a silicon lamination set and a wiring set, the bobbin covers the silicon lamination set and exposes the silicon lamination set, the silicon lamination set comprises the outer peripheral surface, the wiring set is disposed on the bobbin, and the elastic arms are disposed on a bottom side of the bobbin.

12. The stator assembly according to claim 11, wherein the bobbin comprises a retaining wall protruding from the silicon lamination set, the elastic arms are arranged spacedly on the retaining wall, and two cutouts are defined on two sides of each of the elastic arms respectively.

13. The stator assembly according to claim 8, wherein each of the elastic arms comprises a second guiding slope disposed on one side of the perforation.

14. The stator assembly according to claim 8, further comprising a guiding rib disposed on one of the inner side wall and the outer peripheral surface, and a guiding groove defined disposed on another one of the outer peripheral surface and the inner side wall corresponding to the guiding rib.

15. A stator assembly of a water pump, the stator assembly comprising:
a shell seat, comprising a plurality of tenons; and
a stator component, comprising a plurality of elastic arms, and each of the elastic arms comprising a slot;
wherein, the stator component is attached to the shell seat, and the tenons are engaged to a plurality of slots correspondingly.

16. The stator assembly according to claim 15, wherein the shell seat comprises an inner side wall to enclose a receiving space, and the tenons are disposed spacedly on a bottom side of the receiving space.

17. The stator assembly according to claim 15, wherein each of the tenons comprises a first guiding slope, and each of the elastic arms comprises a second guiding slope disposed on one side of the slot.

18. The stator assembly according to claim 15, wherein the shell seat comprises a shut-off defined on one side of each of the tenons.

19. The stator assembly according to claim 15, wherein the stator component comprises a bobbin, a silicon lamination set and a wiring set, the bobbin covers the silicon lamination set and exposes an outer peripheral surface of the silicon lamination set, the wiring set is disposed on the bobbin, and the elastic arms are disposed on a bottom side of the bobbin.

20. The stator assembly according to claim 19, wherein the bobbin comprises a retaining wall protruding from the silicon lamination set, the elastic arms are arranged spacedly on the retaining wall, and two cutouts are defined on two sides of each of the elastic arms respectively.
